(19) United States
(12) Patent Application Publication
(10) Pub. No.: US 2004/0049794 A1
(43) Pub. Date: Mar. 11, 2004

(54) Method for managing audiovisual broadcast recordings and associated devices

(76) Inventors: Jiang Shao, Rennes (FR); Yves Maetz, Melesse (FR)

Correspondence Address: Joseph S Tripoli, Patent Operations-Thomson multimedia Licensing Inc, CN 5312, Princeton, NJ, 08540-0028, US

(21) Appl. No.: 10/451,899

(22) PCT Filed: Dec. 19, 2001
(86) PCT No.: PCT/FR01/04071

(30) Foreign Application Priority Data
Dec. 28, 2000 (FR) 00 17182

(51) Int. Cl. H04N 7/173; H04N 7/16; H04N 5/445

(52) U.S. Cl. 725/89; 725/134; 725/142; 725/58

(57) ABSTRACT

The invention relates to a process for managing recordings of data originating from a broadcasting network. The process analyses whether recording resources are available at the moment envisaged for executing the task envisaged, and as appropriate, for reporting the execution of this task during a next re-broadcasting of the data. An improvement consists in instigating a search for the equivalent resources, then instigating a negotiation with the current users of the resources when no equivalent resource is available. The invention also relates to a device and a centre for the implementation of the process.

The invention relates to a process for managing recordings of audiovisual programs within a digital communication network, a device for storage and a centre for management of the recordings.

A digital communication network comprises apparatuses linked together by a communication bus, for example, the IEEE 1394 bus, using wires or waves. The communication network comprises, for example, the following apparatuses: a terminal allowing users to view audiovisual programs, to enter network control parameters and to ascertain the state of the network, a digital television receiver (a decoder for example) capable of receiving audiovisual programs and service information originating from a broadcasting network, a device for storing the audiovisual programs, a modem, etc. The service information contains indications about the broadcasting of the programs, this information can be consulted on the terminal, for example, in the form of an Electronic Program Guide (EPG for short). The list of apparatuses is not exhaustive. There may be several of each type of apparatus within the communication network, for example it is conceivable that, for a domestic communication network, each room of the dwelling may have a terminal, that several receivers may make it possible to receive programs originating from several broadcasting networks, and that the communication network may have several storage devices or different type, for example a digital video recorder and a hard disk.

In such a communication network, one finds first apparatuses which provide the user with a service via the communication network and second apparatuses which receive and subsequently provide this service to the network. For example, the viewing screen of a terminal allows the users to watch a program originating either from a receiver or from a storage device.

The digital communication network allows the users and the applications to share resources within a dwelling. However, it may happen that, at the same moment, users who have different terminals, want to watch different audiovisual programs originating from one and the same digital receiver or from one and the same storage device. The sharing of the resources gives rise to conflicts of use. A typical problem entails a user or an application needing to make a recording while one or more of the necessary resources are already busy with another task. The inability to successfully accomplish a task of recording a program may be due to the unavailability of a receiver the unavailability of the storage device and/or the insufficiency of bandwidth necessary for sending the program over the communication network. The problem of resolving conflicts related to the programming or to the unavailability of the resources may arise. For example, when it is envisaged to record a program and when at the moment of its broadcasting, the envisaged resource is not available, recording is abandoned. The user realizes too late that the recording has not been performed, which is unsatisfactory for him.

The present invention allows better use of the service indications transmitted by the broadcasting network so as to optimize the use of the resources of the communication network. The present invention thus makes it possible to optimize the use of the recording devices connected in a network.

The present invention consists of a process for managing recordings within a communication network, the said communication network comprising at least one means for receiving audiovisual programs and service information broadcast by a broadcasting network and a plurality of devices for recording the said audiovisual programs; the process comprising a preliminary step of entering parameters for programming a recording of an audiovisual program at a specified moment and into a specified recording device, characterized in that it comprises the following steps:

a) at the specified moment, testing whether the specified storage device is available;

b) in the case of negative response to step a), searching for at least one other moment of broadcasting of the program;

c) if the program is broadcast later, modification of the specified moment with a view to recording during a later broadcast.

In this way the network searches for a later broadcast of the program and modifies the initial parameters so that the task executes during a later broadcast. The user not needing to intervene, the network takes responsibility for managing conflicts.

According to a first improvement, the process searches for another recording device which is available to execute the recording of the program at the specified moment. If the search is fruitful, then the programming parameters are modified so that the task executes with the aid of another recording device.

According to another improvement, if the two attempted substitutions of the time and of the device prove to be fruitless, the network instigates a negotiation step so as to determine whether tasks in progress can relinquish the resources required to the task to be executed. If so, the task in progress is interrupted and the resource thus released is allocated to the recording task which has to be instigated.

According to another improvement, at the moment of a re-broadcasting of the program, if the appliance initially envisaged is not available, the process comprises a step of searching for an equivalent appliance so as to perform the recording.

The subject of the invention is also a device for recording audiovisual programs received through a broadcasting network comprising a means of entering parameters for programming a recording, the said parameters comprising at least a specified moment of recording corresponding to a broadcast a memory for storing the said parameters and a means for receiving service information specifying the broadcasts on the broadcasting network of the said audiovisual programs characterized in that it furthermore comprises a means for selecting another broadcast when the recording device is not available at the specified moment, and a means for modifying in the memory the moment of recording so as to write the selected moment of broadcasting.

According to an improvement, if the envisaged device is busy at the specified moment, another recording device that might be available may be used to perform the recording of the program at the specified moment. According to another improvement, if the program is not broadcast later and if no other storage device is available, a means of negotiation is activated so as to determine whether tasks in progress can relinquish the resources required to the task to be executed. If the means of negotiation has allowed the interruption of a task in progress, the resource thus released is activated so as to perform the task to be executed.

The subject of the invention is also a centre for managing a communication network connected by a digital bus to at least one receiver of audiovisual programs broadcast by a broadcasting network and a plurality of recording devices, the centre comprising a processing unit, a memory containing a program and parameters for programming a recording comprising at least one specified moment of recording corresponding to a broadcast a means for receiving service information specifying the broadcasts of the said audiovisual programs on the broadcasting network, characterized in that it furthermore comprises a means of selection of another broadcast, the said means of selection being activated when the programmed recording device is not available at the specified moment, and a means of modifying in the memory the specified moment of recording so as to write the selected moment of the recording.

Other characteristics and advantages of the present invention will emerge from the description of the exemplary embodiments which follow, taken by way of nonlimiting examples with reference to the appended figures in which:

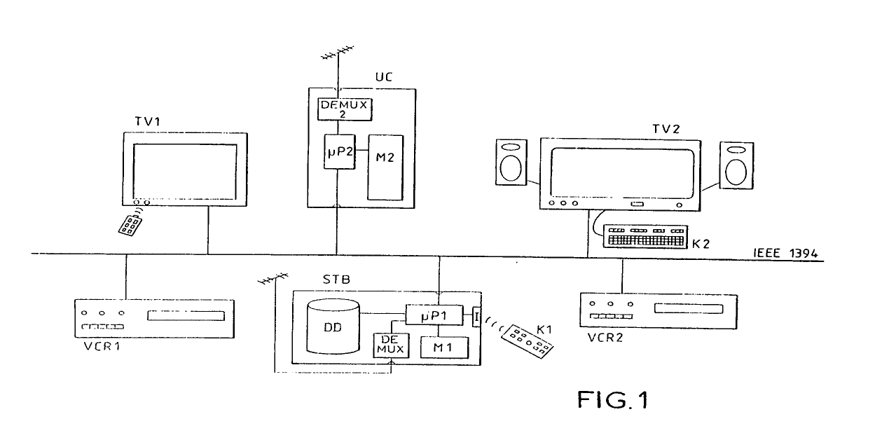

FIG. 1 represents a diagram of a home automation network in which the invention is implemented;

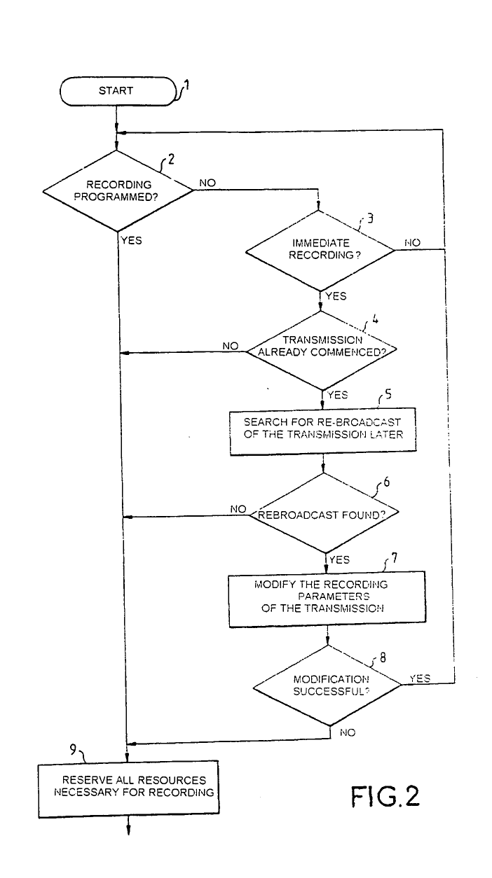

FIG. 2 represents a first part of the flowchart for executing the various steps of the process.

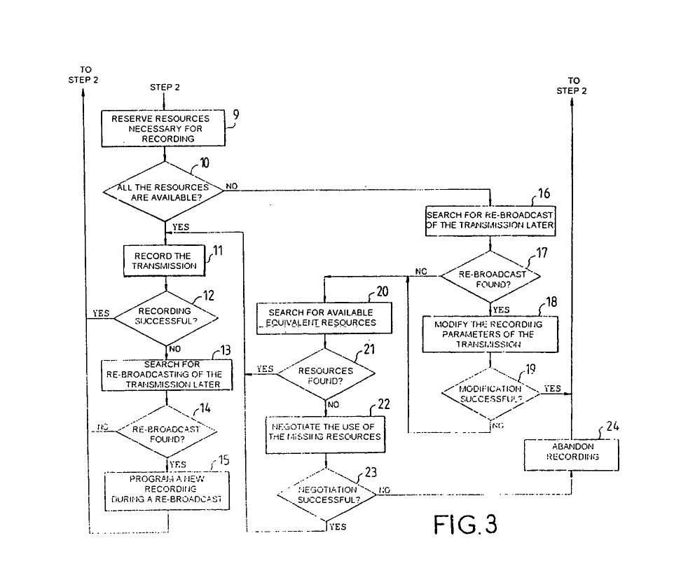

FIG. 3 represents a second part of the flowchart for executing the various steps of the process.

A digital communication network according to a present exemplary embodiment is described in FIG. 1. This network comprises for example the following apparatuses: a decoder STB furnished with a processing unit μP1, with a memory M1 making it possible to store programs and data, with a tuner and with a demultiplexer DEMUX making it possible to receive programs from a broadcasting network, with an interface I making it possible to receive signals from a remote control K1, and with a hard disk DD of large capacity, three means for storing audiovisual programs: two digital video recorders VCR1 and VCR2 and the hard disk DD two television screens TV1 and TV2, the second of which is furnished with a keypad K2 and can serve as terminal to enter commands into the network. The network also has available a telephone link with the aid of a modem (MODEM) integrated into the decoder, or constituting an independent element connected to the network. All these apparatuses are linked together by a digital bus using for example the IEEE 1394 standard.

The network also comprises a network manager making it possible to ascertain the state of availability of the apparatuses connected to the bus. The manager receives requests to execute tasks and allots them to one or more apparatuses capable of successfully accomplishing them. Depending on the mode of management of the network, the manager is not located at the same place. If the management is distributed, the manager is in the form of a program duplicated in each apparatus. Each apparatus is furnished with an identifier ID (for example, the “ID node” allocated by the manager of the IEEE 1394 bus). When a request is instigated allocation is performed according to a very simple protocol: the first apparatus interrogated is the one which has the smallest value of identifier. It verifies whether it is capable of performing all or part of the request and informs the other apparatuses thereof. The dialogue continues with the other apparatuses, while increasing the identifier value. Each apparatus stores the parameters of all the recording tasks that it has to execute. If the management of the network is of centralized type, the network manager is embodied by a central unit (UC) controlling the various apparatuses and sending them individually the orders to be executed. The central unit comprises a processing unit (μP2), a memory (M2) for storing a program and parameters for programming a recording, and a tuner and a demultiplexer DEMUX2 making it possible to receive at least the service information relating to the broadcasting of the programs. As a variant, the central unit UC can receive the service information from the decoder STB via the IEEE 1394 bus.

The decoder receives digital data transmitted by a satellite. The digital content of these data are, for example, images in the MPEG format, constituting audiovisual programs. For example, the data received are formatted according to the DVB standard established by the ETSI (“European Telecommunications Standards Institute”) published in September 1997 under the reference EN300 468—V1.3.1 or under the reference REN/JTC-00DVB-43. The broadcast data also comprise service information which specifies the moments of broadcasting of the various audiovisual programs. This service information is defined by the DVB-SI specifications (“Digital Video Broadcast—specification for Service Information”).

According to the present exemplary embodiment, the service information may also originate from other sources, for example, from a server accessible via the Internet. The means of receiving the audiovisual programs is a tuner. The programs are then stored either in the hard disk of the decoder, or with the aid of a digital video recorder in magnetic tape cassettes. The data are subsequently read from the recording device, forwarded via the digital network and viewed on one of the two television screens TV1 or TV2.

With the aid of the information displayed on the screen of the terminal, the user can ascertain the programs which are broadcast next. He runs through the information with the aid of a user interface, that utilizes the service information broadcast in the streams or obtained through a service, for example, the Internet. The user enters his commands with the aid of the remote control or keypad, and the indications displayed on the screen. He can thus program the recording of a program which is broadcast at certain moment(s). Within the field of digital television, the programs are broadcast several times according to the carousel technique. Thus the user can choose the moment at which he wants to view them and also view again several times a program which he particularly liked. Our invention uses this characteristic to optimize the management of the recordings.

The parameters entered by the user are recorded in the memory of one of the apparatuses of the network. A central management unit (UC) may be available to the communication network. This central unit receives the commands given by the user on the keypad K2 and controls in a centralized manner all the apparatuses connected to the network. In other cases, as for example the HAVI network, management of the network is sited remotely in each apparatus. The recording parameters are sent over the network, the apparatus capable of performing the task retrieves them and stores them in its memory. At the appropriate moment, the network sends the data of the program to it in digital form and it records them.

For example, a user is interested in a program but the latter is not broadcast at moments when he is present. He thus decides to program the recording of the program.

FIGS. 2 and 3 show a flowchart of the running of the process according to an exemplary embodiment. The example describes an embodiment with the aid of an HAVI network the module for managing the recordings being in the form of a program duplicated in at least some of the apparatuses of the network (VCR1, VCR2, STB). In particular it is located in the memory M1 of the decoder STB, this module making it possible to record the programs in the hard disk DD. The program is composed of a certain number of functional blocks. A first block comprising steps 1 to 8, executes the management of an immediate recording. A second block comprising steps 9 to 10 makes it possible to determine the availability of the resources necessary for the execution of the envisaged task. A third block contains steps 11 to 15 for executing the envisaged task. A fourth block comprising steps 16 to 24 consists in searching for an alternative solution for executing the envisaged task. This fourth block comprises in particular a set of negotiation steps.

The network management program is set going in step 1. In step 2, the program tests whether a task is programmed, that is to say whether a recording is to be executed at this moment. To carry this out, it can for example read the internal clock of the recording device, and compare the current temporal value with the start times of the programmed recordings. If the trigger time for a recording task is reached, the program jumps to step 9, which consists in reserving the resources for successfully accomplishing the programmed recording task.

If no recording is programmed at the current time the program tests (step 3) whether an immediate recording is invoked by a user. An immediate recording is triggered when, for example, a user presses the record button of the video recorder. If the response is negative, the program returns to step 2. If the response is positive, the program then tests whether the program has already commenced. If this is not the case, the program jumps to step 9 to reserve the resources and be ready to instigate this immediate recording. If the program has already commenced, it is preferable to wait for a new re-broadcast so as to record a complete program. This is why in step 5, the program searches for the later broadcasts of this program and tests whether it is possible to record the program later (step 6). The search is performed by analysing the service information, broadcast in the DVB-SI tables by the broadcasting network, or obtained on a server via, for example, the telephone network. If there is no re-broadcast, the program jumps to step 9 to record at least a part of the program. In the converse case in step 7 the recording parameters are modified so as to take account of The later broadcasts. Then (step 8), the program tests whether the modification is possible. If it is, the program returns to step 2. If it is not, the program continues to step 9.

In step 9, the program instigates an allocation request and reserves the resources for successfully accomplishing the recording task. If the user wants to record a broadcast program, he must have at least one recording device (hard disk or video recorder), a means of reception (tuner), and a certain amount of bandwidth available on the network. In step 10, the program tests whether these necessary resources are currently available. If they are, the program instigates the envisaged recording (step 11) using the resources reserved in step 9. At the end of recording, the program verifies its proper running (step 12). If the recording ran properly, the program returns to the start, in step 2. In the converse case, for example, when a user has manually retrieved the recording device for his own use the program searches for the later broadcasts of the program to be recorded (step 13). If the search is fruitless, the program no longer being broadcast (step 14) then it is no longer possible to record it again. The program returns to step 2. If on the other hand, other broadcasts are envisaged, the program jumps to step 15 of entering new recording parameters into the memory of the device, then the program returns to the start, and waits for the moment specified in the parameters to instigate this recording.

Following step 10, if not all the resources are currently available, the program jumps to step 16 for searching for the later broadcasts of this program. If the program discovers in step 17 that the program is broadcast later, then in step 18 a new programming request is stored together with the parameters of the next broadcast. Then (step 19), the program tests if the modification has succeeded. If the modification has succeeded the program jumps to step 2, otherwise the program continues in sequence to step 20.

If it is not possible to postpone the recording, the program instigates a phase of searching for the equivalent resources (steps 20 and 21), then of negotiating the allocation of the resources comprising steps 22 to 23. In step 20, the program searches for whether an equivalent resource (for each necessary missing resource) is available. For example, the recording of an audiovisual program may be made on a video recorder, but also on a hard disk. The test in step 21 makes it possible to go to step 11 of recording when all the missing resources are found. Otherwise, the program goes to step 22 of negotiation for the missing resources. This step consists in requesting the users (or applications) who are currently using the missing resources to relinquish them to it. The program sends an abandon request to the various procedures that are using a missing resource, and receives back a cue indicating whether or not the resource has been released. For example, if a resource is busy copying a content from one medium to another this task possibly being staggered in time, the transfer application decides to release the resource. If the resource is a receiver receiving a program that a user is watching, this user is prompted with a message inviting him to abandon viewing. If he refuses, the resource is not released.

If the result of the negotiation is positive in favour of the envisaged task, that is to say the program obtains the missing resources that it needed to execute the envisaged task, the program jumps to step 11, instigating recording on the released resources. If the result is negative, it is not really possible to perform the envisaged task, the program therefore erases it (step 24) and returns to step 2. Advantageously, the program advises the user, through a message, of the abandonment of recording.

When the program finds in step 17 a re-broadcast of the program, the parameters of the next broadcast are recorded and then the program loops back to step 2 to wait for the next re-broadcast. When this moment arrives, the program determines whether the envisaged recording device is available and if it is not, searches for other recording devices. In this way, the program takes account of the later broadcasts of the program and the availability of storage devices in the course of these broadcasts. It searches for a solution consisting in using a storage device other than that initially envisaged and by programming the recording during a later broadcast.

The exemplary embodiments of the invention which were presented hereinabove have been chosen for their concrete nature. It would, however, not be possible to exhaustively list all the embodiments covered by this invention. In particular, any step or any means described may be replaced by an equivalent step or means without departing from the scope of the present invention.

1. Process for managing recordings within a communication network, the said communication network comprising at least one means for receiving audiovisual programs (STB) and service information broadcast by a broadcasting network; the process comprising
a) a preliminary step of entering parameters for programming a recording of an audiovisual program at a specified moment and into a specified recording device,
b) at the specified moment, testing whether the specified storage device is available (10);
c) in the case of negative response to step a), searching for at least one other moment of broadcasting of the program (16, 17) in the broadcast service information;
d) if the program is broadcast later, modification of the specified moment with a view to recording during a later broadcast (18)
characterized in that the network comprises a plurality of devices (VCR1, VCR2, DD) for recording the said audiovisual programs and in that the process furthermore comprises the step:
e) if the program is not broadcast later, searching for another recording device connected to the network and execution of the recording at the specified moment (21,21) in an available device.

2. Process for managing recording according to claim 1 characterized in that it furthermore comprises the steps of:
f) if no recording device is available, negotiating with the users or the applications using the missing devices so as to determine whether the latter can release the said missing devices (22,23);
g) if the missing devices are obtained, instigating the recording on the device thus released (11).

3. Process for managing recording according to claim 1 or 2, characterized in that, if at the moment of a re-broadcasting of the program, the specified device is not available, the process searches for another equivalent recording device (VCR1, VCR2, DD) for performing the recording.

4. Process for managing recording according to any one of the preceding claims; characterized in that following the recording of the program (11), it furthermore comprises the steps:
h) of verifying the recording (12);
i) if the recording ran badly, of a step of searching for at least one other moment of broadcasting of the said program and of a step of programming a new recording (13, 14, 15).

5. Process for managing recording according to any one of the preceding claims; characterized in that the audiovisual programs are of digital kind.

6. Device (VCR1, VCR2, DD) for recording audiovisual programs received through a broadcasting network comprising a means (K1) of entering parameters for programming a recording, the said parameters comprising at least a specified moment of recording corresponding to a broadcast, a memory (M) for storing the said parameters, and a means (DEMUX) for receiving service information specifying the broadcasts on the broadcasting network of the said audiovisual programs, characterized in that it furthermore comprises a means (μP1, M1) for selecting another broadcast when the recording device is not available at the specified moment, and a means for modifying in the memory (M1) the moment of recording, so as to write the selected moment of broadcasting, of a means for searching for another recording device when the device is not available during the broadcasting of the program, and a means for sending new programming data so as to activate the recording on this other device if the latter is available.

7. Recording device according to claim 6 characterized in that it furthermore comprises a negotiation means (22) activated when no recording device is available to record the program, the said negotiation means receiving a cue of release of a recording device and instigating the execution of the recording of the program on the device thus released.

8. Recording device according to any one of claims 6 or 7 characterized in that it comprises a means (12) for verifying the recording performed and a means (13, 14, 15) for searching for another moment of broadcasting of the said program so as to record the program again, if the first recording ran badly.

9. Recording device according to any one of claims 6 to 8, characterized in that the recording device is a digital video recorder.
